(19) United States
(12) Patent Application Publication
(10) Pub. No.: US 2025/0138841 A1
(43) Pub. Date: May 1, 2025

(54) INTELLIGENT PREFERENCE BASED USER INTERFACE

(71) Applicant: International Business Machines Corporation, Armonk, NY (US)

(72) Inventors: Jennifer M. Hatfield, Portland, OR (US); Kara A. Smoot, Baltimore, MD (US); Vinod A. Valecha, Pune (IN); Uma Subbu, Chicago, IL (US); ucia Larise Stavarache, Columbus, OH (US); Charles Diggs, JR., Palo Alto, CA (US)

(21) Appl. No.: 18/385,131

(22) Filed: Oct. 30, 2023

(51) Int. Cl. G06F 9/451; G06F 11/34

(52) U.S. Cl. CPC G06F 9/451; G06F 11/3438

(57) ABSTRACT

A display method, system, and computer program product for displaying a user interface (UI) based on user preferences including collecting, by one or more processors, user preferences from user interaction with a prompt-based menu system and natural language processing, creating, by the one or more processors, a user persona based on the user preferences, and generating, by the one or more processors, a user interface (UI) customized for the user based on the user persona.

### BACKGROUND

The present invention relates generally to a display method, and more particularly, but not by way of limitation, to a system, method, and computer program product for displaying a user interface based on user preferences.

Users have different ways of absorbing information. For example, some people find it easier to learn from video-based content, while others prefer text-based learning. Switching between the two learning mediums allows one's brain to operate and absorb knowledge in different ways, in turn improving one's memory of content. Similarly, a user may benefit from the ability to control content that is displayed. This includes controlling elements and ways they will be represented. It will impact the user's experience including usability, accessibility, speed of learning, and their overall engagement with the product.

Many times a user may leave or abandon a task on a site due to a perceived complexity, unfamiliarity, or hard-to-use experience.

Therefore, there is a problem in the art that there is a lack of optimization or tailoring of a user interface (UI) to a particular user based on a preference. Current solutions have a lack of control over the visual representation of content which in turn leads to poor experiences or the abandonment of the task on a site or application.

### SUMMARY

In view of the above-mentioned problems in the art, the inventors have considered a technical solution by using prompts to gain additional insight about users that tie in towards long-term goals, thereby providing incentive for increased personalization in exchange for more information that can enhance the platform and usage.

Indeed, the invention provides a technical solution to the technical problem in the art by learning a user's preferred and/or natural ability to absorb data and information in the quickest manner. For instance, a user may prefer pictures to words, graphs to numbers, sounds to words, sentiments to facts (e.g., feeling vs factual), etc. By understanding a user's preferences, the user interface (UI) may assimilate the best way to approach the user and display the patterns/designs/language that is tailored to the user's preferences and natural learning style.

In an exemplary embodiment, the present invention can provide a computer-implemented method for displaying a user interface (UI) based on user preferences, the computer-implemented method including collecting, by one or more processors, user preferences from user interaction with a prompt-based menu system and natural language processing, creating, by the one or more processors, a user persona based on the user preferences, and generating, by the one or more processors, a user interface (UI) customized for the user based on the user persona.

In another exemplary embodiment, the present invention can provide a display computer program product for displaying a user interface (UI) based on user preferences, the display computer program product comprising a computer-readable storage medium having program instructions embodied therewith, the program instructions executable by a computer to cause the computer to perform: collecting, by one or more processors, user preferences from user interaction with a prompt-based menu system and natural language processing, creating, by the one or more processors, a user persona based on the user preferences, and generating, by the one or more processors, a user interface (UI) customized for the user based on the user persona.

In another exemplary embodiment, the present invention can provide a display system for displaying a user interface (UI) based on user preferences, the display system including a processor and a memory, the memory storing instructions to cause the processor to perform: collecting, by the processor, user preferences from user interaction with a prompt-based menu system and natural language processing, creating, by the processor, a user persona based on the user preferences, and generating, by the processor, a user interface (UI) customized for the user based on the user persona.

Other details and embodiments of the invention will be described below, so that the present contribution to the art can be better appreciated. Nonetheless, the invention is not limited in its application to such details, phraseology, terminology, illustrations and/or arrangements set forth in the description or shown in the drawings.

Rather, the invention is capable of embodiments in addition to those described and of being practiced and carried out in various ways and should not be regarded as limiting.

As such, those skilled in the art will appreciate that the conception upon which this disclosure is based may readily be utilized as a basis for the designing of other structures, methods and systems for carrying out the several purposes (and others) of the present invention. It is important, therefore, that the claims be regarded as including such equivalent constructions insofar as they do not depart from the spirit and scope of the present invention.

### BRIEF DESCRIPTION OF THE DRAWINGS

Aspects of the invention will be better understood from the following detailed description of the exemplary embodiments of the invention with reference to the drawings, in which:

FIG. 1 depicts a computing environment 100 according to an embodiment of the present invention;

FIG. 2 exemplarily shows a high-level flow chart for a display method 200 according to an embodiment of the present invention;

FIGS. 3-6 exemplarily depict user interfaces (UIs) and modifications as a result of the display method 200;

FIG. 7 exemplarily depicts a second high-level flow chart for the display method 200 according to an embodiment of the present invention; and

FIG. 8 exemplarily depicts a third high-level flow chart for a display method 800 according to an embodiment of the present invention.

### DETAILED DESCRIPTION

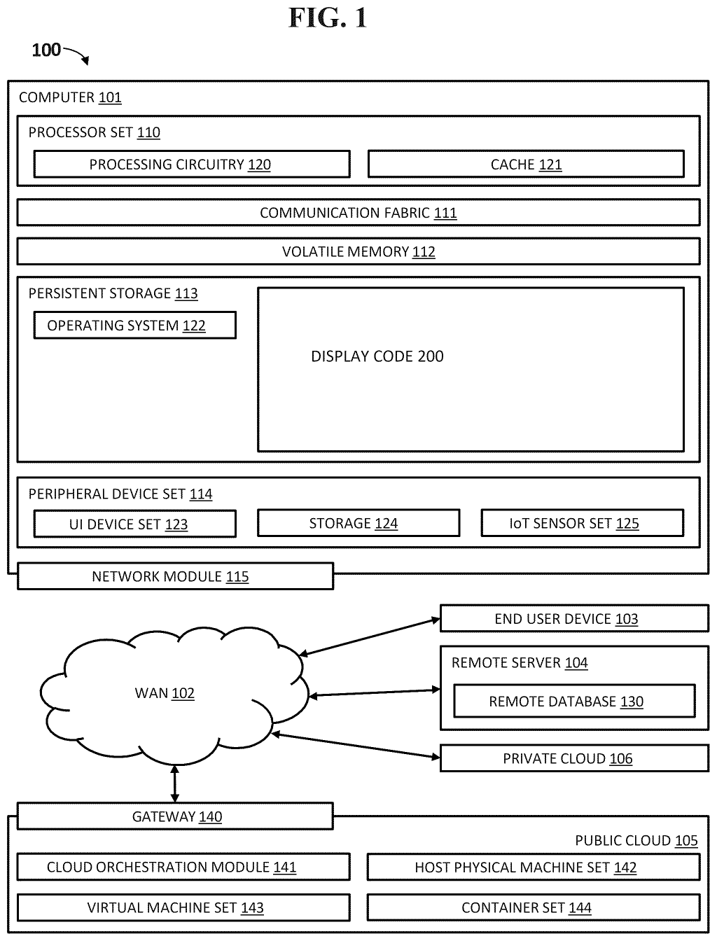

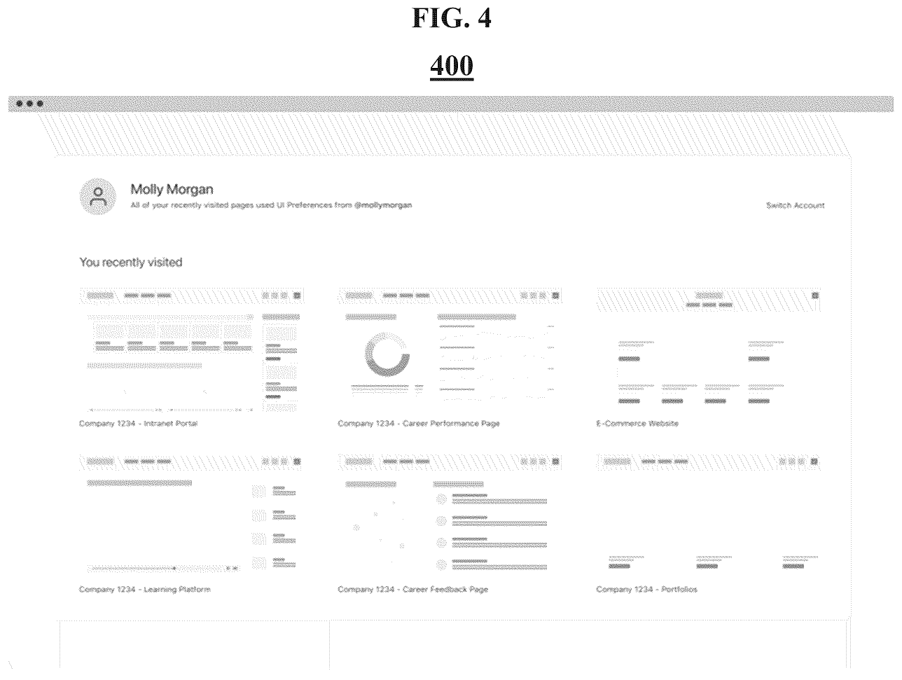

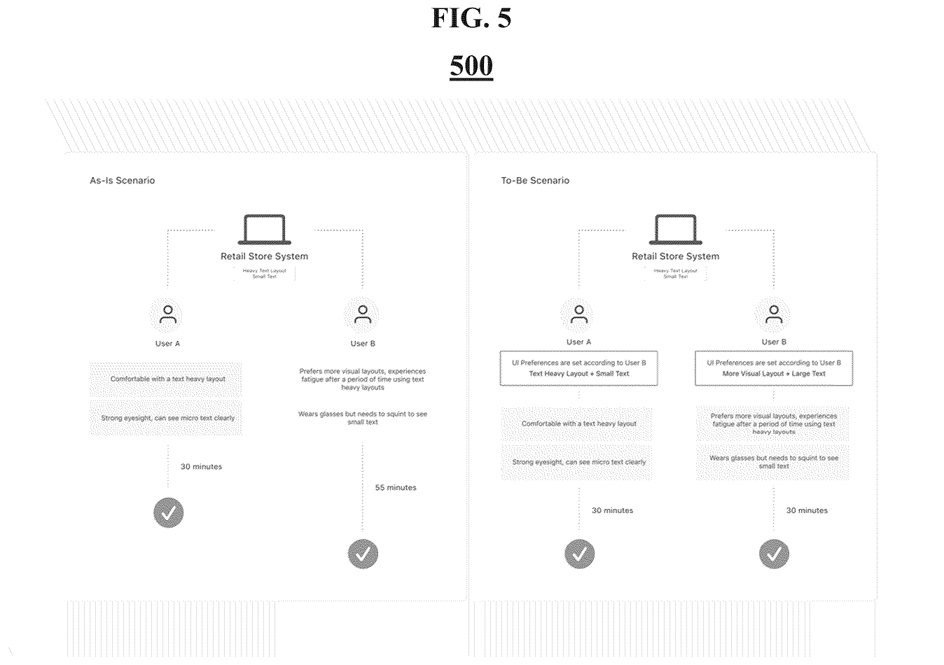

The invention will now be described with reference to FIGS. 1-8, in which like reference numerals refer to like parts throughout. It is emphasized that, according to common practice, the various features of the drawing are not necessarily to scale. On the contrary, the dimensions of the various features can be arbitrarily expanded or reduced for clarity.

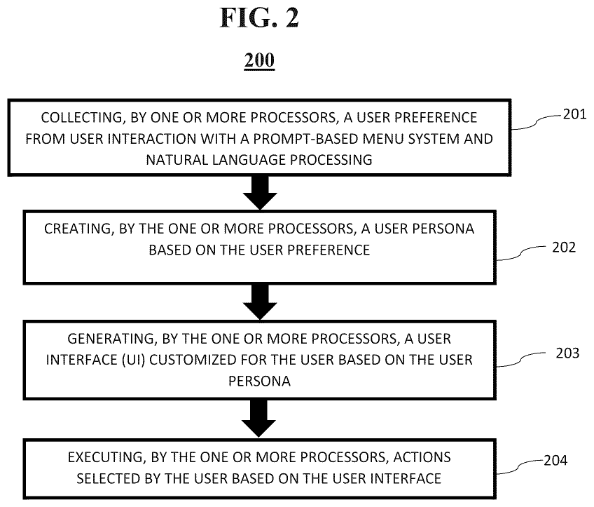

With reference now to the exemplary method 200 depicted in FIG. 2, the invention may include various steps to learn a user's preferred and/or natural ability to absorb data and information in the quickest manner, and then, through understanding a user's preferences, the UI may assimilate the best way to approach the user and display the patterns/designs/language that is tailored to their preferences and natural learning style.

The display method 200 according to an embodiment of the present invention may act in a more sophisticated, useful and cognitive manner, giving the impression of cognitive mental abilities and processes related to knowledge, attention, memory, judgment and evaluation, reasoning, and advanced computation. A system can be said to be “cognitive” if it possesses macro-scale properties—perception, goal-oriented behavior, learning/memory and action—that characterize systems (i.e., humans) generally recognized as cognitive.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

With reference generally to FIGS. 1-9, the invention uses prompts to gain additional insight about users that tie in towards long-term goals, providing incentive for increased personalization in exchange for more information that can enhance the platform and usage. For example, earbuds with a special audio quality can be provided to the shape of a user's ear by seeing inside of the ear.

The embodiments of the invention include a prompt-based system that learns about a user's preferences on the first launch and improves by leveraging AI over the several subsequent launches. The user's UI preferences are saved into their user folder and is applied across a range of products and applications. These folders are then referenced to create a “most likely preferred UI” for users and is further improved based on the actual user's UI preferences.

The embodiments of the invention further include, as described later, continuous learning based on existing user personas and users' interaction with the product. Further, the embodiments of the invention further include UI recommendations where, based on the user's persona, the UI is altered in a way that the user can consume information quickly and easily.

The embodiments of the invention can also be personalized in that the user can update their persona any time to reflect these changes across a range of products they use. Further, the user can control the implementation in that, as described later, the user has full control over what their experience can be like while interacting with a platform, right from typefaces, colors used, layouts, themes, animation and motion, and ways in which information is presented-such as documents, slideshows, carousels, images, or text. The use of the customization can also be for all elements, or a specific element, because embodiments of the invention may enable the user to decide whether they would like all of the products and applications that they use be customized based on their user preference folder/persona. Alternatively, the user can choose to pick specific applications to have a customized user experience.

More specifically, with reference to FIG. 2, in step 201, user preferences are collected from user interaction with a prompt-based menu system and natural language processing.

In step 202, a user persona is created based on the user preferences.

In step 203, a user interface (UI) is generated that is customized for the user based on the user persona.

Further, in step 204, actions selected by the user are executed based on the user interface.

In one embodiment, the user persona may be updated based on a K-Means clustering machine learning algorithm. The updating can be based on grouping the user persona with one or more user personas associated with one or more other users.

Also, the updated user personas of the user and the other users may be stored. Further, the user personas can be manually updated by the user (or other users) that are stored. Further, the user and the other users may specify one or more UIs customized based on the user persona and the other user personas, respectively.

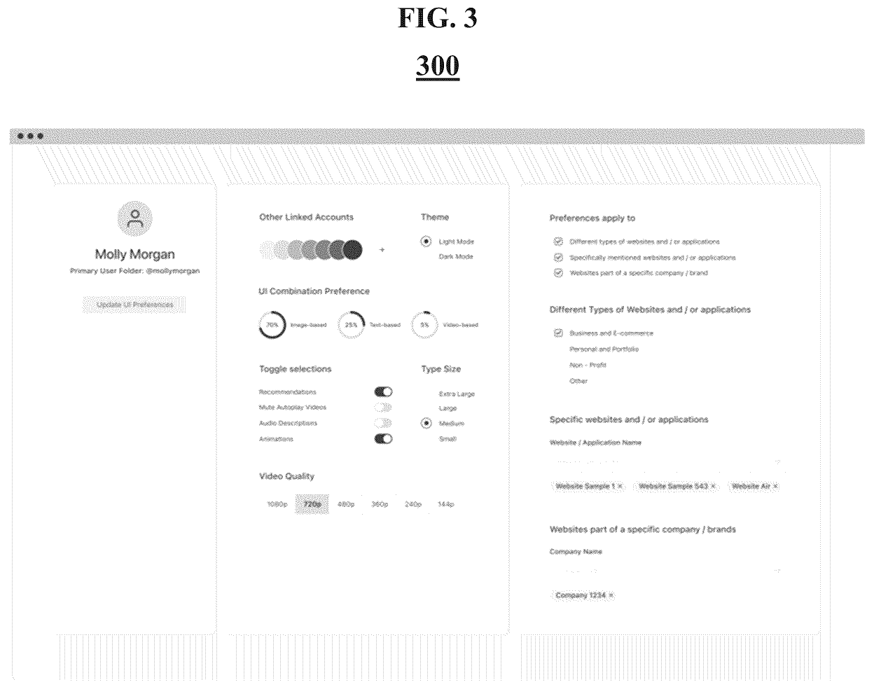

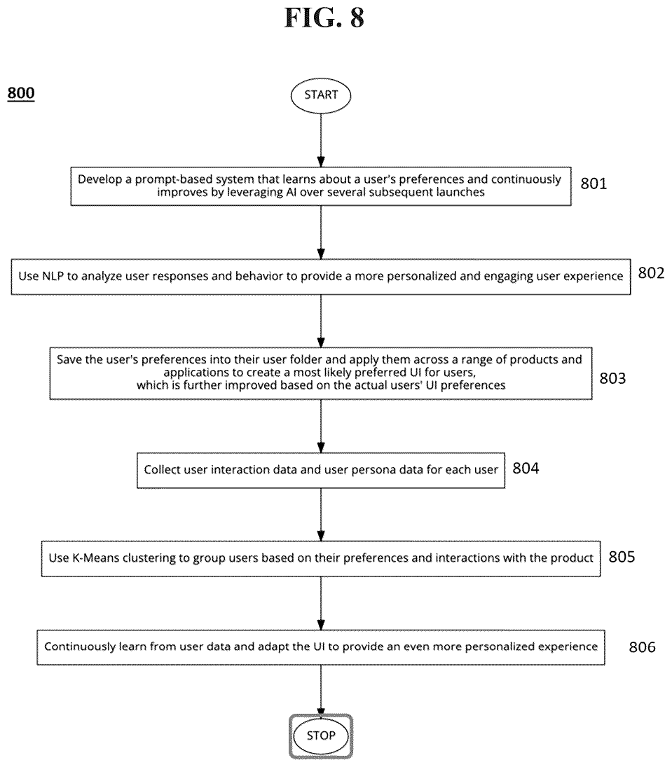

With reference now to FIGS. 3-6 and 8, embodiments of the invention include a prompt-based system that learns about a user's preferences and continuously improves by leveraging AI over several subsequent launches (e.g., such as in Step 801 of method 800 depicted in FIG. 8). The method 200 uses Natural Language Processing (NLP) to achieve this. NLP can be used to develop a prompt-based system that learns about a user's preferences and continuously improves by leveraging AI over several subsequent launches.

In one embodiment, a user is presented with a prompt that asks them to choose between two options: “I prefer to learn through visual aids” or “I prefer to learn through text-based content”. The user selects the first option, indicating that they prefer visual aids. The NLP system would then analyze the user's response and recognize that the user has a preference for visual aids. This preference would be saved in the user's persona, and the invention would adjust the UI accordingly, presenting the user with more visual aids in the future.

Over time, the prompt-based system behind method 200 may use NLP (e.g., see step 802 in FIG. 8) to analyze the user's interactions with the platform and adjust the prompts accordingly. For example, if the invention recognizes that the user interacts with visual aids more frequently than with text-based content, it may prompt the user with more options that relate to visual aids.

As the invention collects more data about the user's preferences and behavior, the invention can use NLP to generate more personalized prompts that are tailored to the user's specific needs and learning style. This could include prompts that ask about specific types of visual aids, such as videos or infographics, or prompts that ask about the user's preferred color schemes or fonts.

By using NLP to analyze user responses and behavior, the invention can provide a more personalized and engaging user experience.

Further, the user's preferences can be saved (e.g., see step 803 in FIG. 8) into a user folder and apply them across a range of products and applications to create a most likely preferred UI for users, which is further improved based on the actual users' UI preferences.

This can be performed by the invention collecting the user's preferences (e.g., see step 804 in FIG. 8) by, for example, through surveys, user testing, and other methods that allow users to provide feedback on their preferred UI elements. Once the user preferences have been collected, they need to be stored in a user folder or database. This folder may contain all the information about the user's preferences, including their preferred typefaces, colors, layouts, themes, animation and motion, and ways in which information is presented such as documents, slideshows, carousels, images, or text.

Next, the stored user preferences can then be applied across a range of products and applications to create a most likely preferred UI for users. This means that when the user accesses different products or applications, the UI may be tailored to their preferences. The invention can further improve the UI based on the actual user's preferences. For instance, if the user's preference for typefaces changes, the invention may learn this and make the necessary adjustments. This continuous learning process ensures that the user's preferences are always up to date and that the UI is always tailored to their needs.

The invention also allows for personalization of the user experience by enabling users to update their persona at any time to reflect changes in their preferences. This means that the system can continuously learn and adapt to the user's changing preferences and provide a personalized experience across a range of products and applications.

For example, if a user prefers dark mode and uses dynamic type, these preferences would be stored in their user folder. The next time the user accesses a website or application, the UI would be automatically adjusted to their preferences. If the user's preferences change over time, then the system would learn this and make the necessary adjustments to provide an even more personalized experience.

The invention also includes continuous learning based on existing user personas and users' interaction with the product. The invention may use K-Means clustering for this (e.g., see step 805 in FIG. 8) continuous learning.

K-Means clustering is a popular unsupervised machine learning algorithm that is used to group similar data points into clusters. In this algorithm, the data points are grouped into k clusters based on their similarity. This algorithm can be used to group users based on their preferences and interactions with the product.

The invention uses K-means clustering by collecting user interaction data and user persona data for each user. The interaction data can include information such as the pages visited, buttons clicked, time spent on the site, etc. The user persona data can include information such as age, gender, location, etc. Features are extracted from the interaction and user persona data. These features can include the number of pages visited, time spent on the site, age, gender, etc.

Then, the K-Means clustering may be used to group users based on their interaction and persona data. The number of clusters can be decided based on the data and the desired level of granularity. The clustering algorithm may group users with similar interaction and persona data into the same cluster. Once the initial clustering is done, a model can be trained using the clustered data. The model can be trained to predict the user's preferences based on their interaction and persona data. The invention can be designed to continuously learn and improve based on the user's interaction and persona data. The model can be updated periodically to incorporate new data and improve the accuracy of the predictions.

Thereby, K-Means clustering is used above to group users based on their interaction and persona data, and the resulting clusters can be used to train a model that predicts the user's preferences. The invention can continuously learn and improve based on new data, thereby making it a powerful tool for developing personalized user experiences.

Next, the invention can alter the UI based on the users' persona in a way that the user can consume information quickly and easily. To do so, the invention may define the UI elements that need to be altered based on the user persona. These could be color schemes, fonts, layouts, themes, animation and motion, and ways in which information is presented-such as documents, slideshows, carousels, images, or text. The user persona may be mapped to the UI elements. For instance, if a user prefers a dark mode, the UI should be altered to show darker colors. Similarly, if a user prefers larger fonts, the UI should be altered to show larger fonts.

Machine learning algorithms such as decision trees or neural networks may then be used to determine the user's persona based on their behavior on the platform. For example, if a user consistently chooses to watch videos rather than read articles, it can be assumed that they prefer video-based content.

The invention may continuously monitor user behavior to determine whether the alterations made to the UI are having a positive impact on the user experience (e.g., see step 806 in FIG. 8). For example, if a user spends more time on the platform after the alterations have been made, it can be assumed that the alterations have been successful. The alterations made to the UI may be fine-tuned based on the feedback received from users. For instance, if users complain that the font size is still too small, the UI should be altered again to show even larger fonts.

The process of mapping the user persona to UI elements may be repeated, using machine learning algorithms, monitoring user behavior, and fine-tuning the alterations. This process should be repeated continuously to ensure that the UI is always optimized for the user's persona.

The invention also may allow the user to update their persona anytime to reflect changes across a range of products they use. The user may also be provided with full control over their experience, from typefaces to animation and motion.

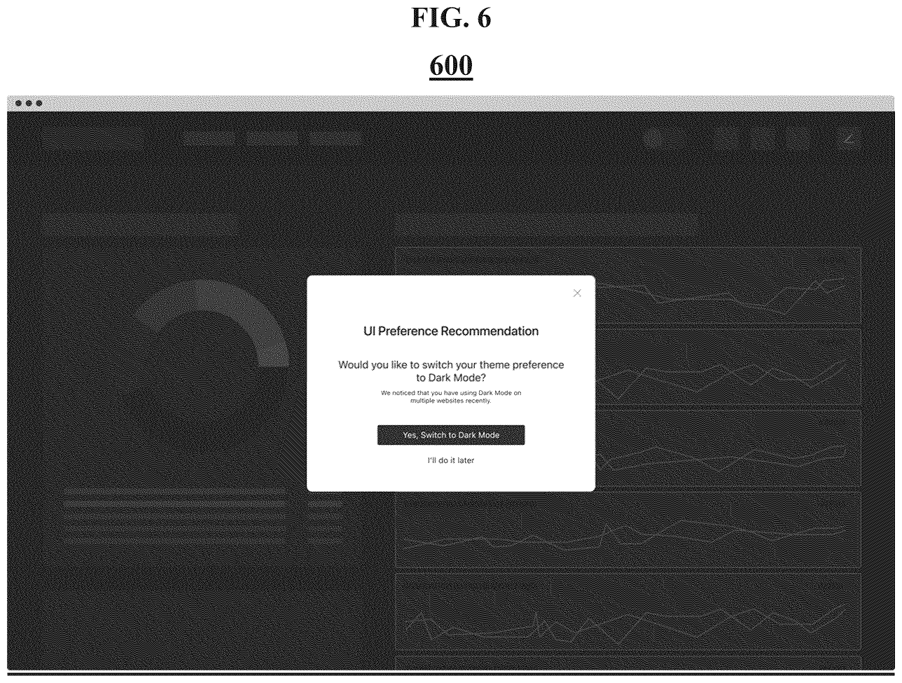

Further, the invention may allow the user to decide whether they want all of the products and applications they use to be customized based on their user preference folder/persona or to choose only specific applications to have a customized user experience (e.g., such as the prompt depicted in FIG. 6).

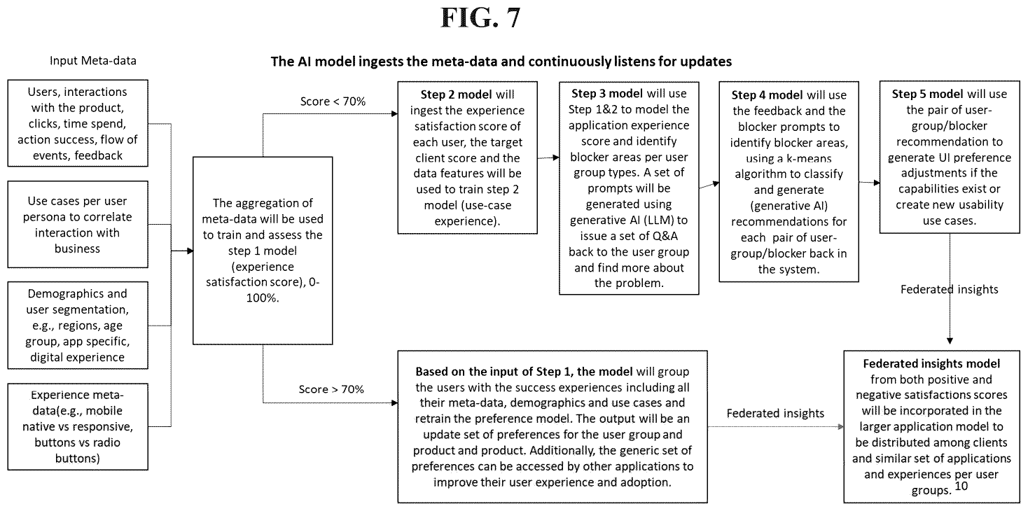

FIG. 7 exemplarily depicts a use case of an artificial intelligence model ingesting meta-data from a user to continuously detect updates to the UI preferences. For example, the input meta-data is aggregated and then a score determines how to loop the meta-data through steps 1 or 2-5 before outputting a model.

Thereby, as a result of the invention as disclosed above, the user is provided with a better experience. That is, due to personalized UI and content, users may spend more time using the product which in return may ultimately benefit the company of the product. Also, cost may be minimized for UI/User Experience (UX) design and developer by the invention identifying UI redundancies and automatically optimizing the experience for all types of users. Further, accurate testing of a product's UI/UX features based on the user's preferences and machine-learning over time (“what works/doesn't work for this type of user?”) are provided by the invention. Further, the invention can be used for any industry, solving complex UI issues and improving usability based on a user's preference.

### EXEMPLARY ASPECTS, USING A COMPUTING ENVIRONMENT

With reference now to FIG. 1, computing environment 100 contains an example of an environment for the execution of at least some of the computer code involved in performing the inventive methods, such as display code 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Further, Applicant's intent is to encompass the equivalents of all claim elements, and no amendment to any claim of the present application should be construed as a disclaimer of any interest in or right to an equivalent of any element or feature of the amended claim.

What is claimed is:

1. A computer-implemented method for displaying a user interface (UI) based on user preferences, the computer-implemented method comprising:
collecting, by one or more processors, user preferences from user interaction with a prompt-based menu system and natural language processing;
creating, by the one or more processors, a user persona based on the user preferences; and
generating, by the one or more processors, a user interface (UI) customized for the user based on the user persona.

2. The computer-implemented method of claim 1, further comprising:
executing, by the one or more processors, actions selected by the user based on the user interface.

3. The computer-implemented method of claim 2, further comprising:
updating, by the one or more processors, the user persona based on a K-Means clustering machine learning algorithm.

4. The computer-implemented method of claim 3, wherein the updating is based on grouping the user persona with one or more user personas associated with one or more other users.

5. The computer-implemented method of claim 4, further comprising:
storing, by the one or more processors, updated user personas of the user and the other users.

6. The computer-implemented method of claim 4, wherein the user persona and the other user personas are manually updated by the user and the other users, respectively.

7. The computer-implemented method of claim 4, wherein the user and the other users specify one or more user UIs customized based on the user persona and the other user personas, respectively.

8. The computer-implemented display method of claim 1, embodied in a cloud-computing environment.

9. A display computer program product for displaying a user interface (UI) based on user preferences, the display computer program product comprising a computer-readable storage medium having program instructions embodied therewith, the program instructions executable by a computer to cause the computer to perform:
collecting, by one or more processors, user preferences from user interaction with a prompt-based menu system and natural language processing;
creating, by the one or more processors, a user persona based on the user preferences; and
generating, by the one or more processors, a user interface (UI) customized for the user based on the user persona.

10. The display computer program product of claim 9, further comprising:
executing, by the one or more processors, actions selected by the user based on the user interface.

11. The display computer program product of claim 10, further comprising:
updating, by the one or more processors, the user persona based on a K-Means clustering machine learning algorithm.

12. The display computer program product of claim 11, wherein the updating is based on grouping the user persona with one or more user personas associated with one or more other users.

13. The display computer program product of claim 12, further comprising:
storing, by the one or more processors, updated user personas of the user and the other users.

14. The display computer program product of claim 12, wherein the user persona and the other user personas are manually updated by the user and the other users, respectively.

15. The display computer program product of claim 11, wherein the user and the other users specify one or more user UIs customized based on the user persona and the other user personas, respectively.

16. A display system for displaying a user interface based on user preferences, the display system comprising:
a processor; and
a memory, the memory storing instructions to cause the processor to perform:
collecting, by the processor, user preferences from user interaction with a prompt-based menu system and natural language processing;
creating, by the processor, a user persona based on the user preferences; and
generating, by the processor, a user interface (UI) customized for the user based on the user persona.

17. The display system of claim 16, further comprising:
executing, by the processor, actions selected by the user based on the user interface.

18. The display system of claim 17, further comprising:
updating, by the one or more processors, the user persona based on a K-Means clustering machine learning algorithm.

19. The display system of claim 18, wherein the updating is based on grouping the user persona with one or more user personas associated with one or more other users.

20. The display system of claim 16, embodied in a cloud-computing environment.
